(19) United States
(12) Patent Application Publication
(10) Pub. No.: US 2013/0247998 A1
(43) Pub. Date: Sep. 26, 2013

(54) METHOD FOR FEEDING ZINC GAS AND APPARATUS THEREFOR

(71) Applicants: Shuichi Ohkubo, Ibaraki (JP); Toshimitsu Fuchigami, Ibaraki (JP); Yoshiki Iwata, Ibaraki (JP)

(72) Inventors: Shuichi Ohkubo, Ibaraki (JP); Toshimitsu Fuchigami, Ibaraki (JP); Yoshiki Iwata, Ibaraki (JP)

(73) Assignees: JNC CORPORATION, TOKYO (JP); TOHO TITANIUM CO., LTD., KANAGAWA (JP); JX NIPPON MINING & METALS CORPORATION, TOKYO (JP)

(21) Appl. No.: 13/990,425

(22) PCT Filed: Nov. 17, 2011
(86) PCT No.: PCT/JP2011/076517

§ 371 Date: May 30, 2013

(30) Foreign Application Priority Data
Nov. 30, 2010 (JP) 2010-266378

(51) Int. Cl. C01B 33/021

(52) U.S. Cl. CPC C01B 33/021
USPC 137/13; 137/334

(57) ABSTRACT

To provide a method and an apparatus for feeding a zinc gas superheated to a boiling point of zinc or higher at a controlled rate of feed. The method for feeding the zinc gas according to the invention includes a step for introducing melt zinc into a zinc gas evaporation apparatus, a step for generating the zinc gas from the melt zinc by inputting electric power corresponding to a rate of feed of the zinc gas to allow zinc to cause self-heating by high-frequency induction heating, a step for introducing the generated zinc gas into a gas heating apparatus, and a step for heating the zinc gas by resistance heating to form a superheated zinc gas. An apparatus for feeding the zinc gas according to the invention is applied to the method, and includes a zinc gas evaporation apparatus, a gas heating apparatus and a control apparatus.

### TECHNICAL FIELD

The present invention relates to a method for feeding a zinc gas and an apparatus therefor. More specifically, the invention relates to a method for feeding a superheated zinc gas at a controlled rate of feed and an apparatus therefor.

### BACKGROUND ART

Photovoltaic power generation draws increasing attention as a new technology for meeting a demand for electric power with preventing global warming in recent years. Photovoltaic power generation is mainly performed according to a method applying a photovoltaic cell using single crystalline or polycrystalline silicon. In response to forecast of a rapid increase in demand for a photovoltaic power generation apparatus, a supply of high-purity silicon being a main material at a low price and in a large amount is required.

Commercially supplied high-purity silicon is currently produced according to a Siemens process. According to the process, electric power cost in production cost is high, and production efficiency is poor due to a batch process production. Furthermore, the process needs facilities for producing trichlorosilane used as a raw material, and also ancillary facilities for separating, recovering and treating unreacted trichlorosilane, hydrogen, by-product silicon tetrachloride or the like from a decomposition gas discharged from a step for producing high-purity silicon according to the Siemens process. When the facts are taken into consideration, the Siemens process is unsuitable as a method for producing high-purity silicon at a low cost and in a large amount.

As one of the methods for producing high-purity silicon, a zinc reduction process is applied to production of high-purity silicon by reducing silicon tetrachloride with a zinc gas. Production of high-purity silicon according to the zinc reduction process has a past record of commercial application, on a small scale, until 1960s. However, commercial production of high-purity silicon according to the zinc reduction process has been discontinued after development and practical application of the Siemens process. Electric characteristics of high-purity silicon produced according to the Siemens process have been better, as compared with high-purity silicon then produced according to the zinc reduction process, and also a demand for high-purity silicon has been mainly for a semiconductor use, and an amount has been limited. Therefore, even though cost is high, production according to the Siemens process has been performed in many cases up to the present time.

A technical study for producing high-purity silicon at a low cost and in a large amount has been continuously conducted, and a report has been issued (Non-patent literature No. 1). As a conclusion of the report, a method comprised by combining production steps below is described to have a possibility of producing high-purity silicon at a lowest production cost even in comparison with the Siemens process or other methods. The method includes:

(1) a step for producing high-purity silicon by reducing silicon tetrachloride with a zinc gas in a fluidized bed to allow formed silicon to grow on charged seed silicon, and discharging the grown silicon;
(2) a separation and recovery step for continuously discharging a by-product zinc chloride gas, an unreacted zinc gas and an unreacted silicon tetrachloride gas from an upper part of a fluidized bed reaction apparatus, collecting zinc chloride and zinc as a mixed liquid by means of a condensation apparatus, and separating the mixed gas from the unreacted silicon tetrachloride gas;
(3) a step for sending the mixed liquid of condensed zinc chloride and zinc to a molten salt electrolysis apparatus to electrolyze the mixed liquid, and recovering chlorine and zinc; and
(4) a step for allowing recovered chloride to react with silicic acid (SiO₂) and carbon, or with metal silicon, and producing silicon tetrachloride, in which zinc subjected to molten salt electrolysis is recycled and reused. Furthermore, the report describes that a pilot-scale production apparatus for producing high-purity silicon at a capacity of 50 tons/year according to the method for producing high-purity silicon is designed, and a trial calculation of a production cost is made, and thus production at a lowest cost can be achieved in comparison with other methods.

With referring to the method described in the report, a study is conducted for achieving production of high-purity silicon according to the zinc reduction process by examining problems in each step. For example, in the step for producing high-purity silicon by reducing the silicon tetrachloride gas with the zinc gas, a method is disclosed in which a vertical reactor is used, and the silicon tetrachloride gas and the zinc gas are fed into the reactor to allow high-purity silicon to grow at a leading edge of a nozzle for feeding silicon tetrachloride and to keep growth downward (Patent literature No. 1). However, in order to produce a large amount of high-purity silicon, a method for feeding a large amount of zinc gas while controlling the gas and an apparatus therefor are required, but a specific method therefor is not disclosed.

As a method for feeding the zinc gas, a method is disclosed in which melt zinc is introduced into a zinc gas generator by means of a plunger, brought into contact with a graphite tray arranged inside the generator and inductively heated from outside, and heated, and thus a zinc gas corresponding to an amount introduced by means of the plunger is generated (Non-patent literature No. 1). However, according to the method, a rate of generating the zinc gas is limited by an amount of heat transfer from the graphite tray, and the method is hard to increase an amount of generated zinc gas per unit time. Moreover, an apparatus material mainly formed of carbon, such as the graphite tray, is not preferred because a certain amount of carbon is mixed in the zinc gas, and also because phosphorus (P) and a heavy metal component such as iron (Fe) contained in graphite is mixed. Moreover, all of introduced melt zinc are gasified, and most of impurities present in the melt zinc are also gasified and entrained into the zinc gas, affecting electric characteristic of high-purity silicon produced according to the zinc reduction process using the zinc gas.

An apparatus is disclosed in which previously purified metal grains are continuously charged into an apparatus made from quartz, the charged metal grains are further inductively heated from outside to prepare a molten metal, the molten metal corresponding to a charged amount is flowed down into an evaporation vessel, and a flowed-down molten metal is heated from outside to totally evaporate the metal, and thus a metal gas is generated (Patent literature No. 2). However, according to the constitution, the metal gas cannot be generated in an increased amount per unit time because purification treatment up to a necessary purity of a metal to be charged is required in advance, and because an amount of evaporation is limited due to a limited amount of heat from outside of the evaporation vessel.

Here, a problem upon generating the zinc gas from the melt zinc according to a high-frequency induction heating system is explained. The high-frequency induction heating system is applied to pass an induced current through zinc per se to allow self-heating, and when a temperature of the melt zinc reaches a boiling point of zinc, the temperature of the melt zinc does not exceed the boiling point temperature of zinc even if excess electric power is input, and the zinc gas corresponding to input excess electric power is generated. The temperature of the thus generated zinc gas also is at the boiling point temperature of zinc, and thus when the zinc gas is brought into contact with a surrounding low temperature part (part cooler than the boiling point temperature of zinc), the zinc gas is cooled and part thereof comes into a dew formation (condensation) state. In consideration of feed of the zinc gas to a zinc reduction reaction, the zinc gas generated in a zinc gas feed apparatus should be transferred in a vapor phase state, and for the purpose, a generated zinc gas is required to be heated to a temperature equal to or higher than the boiling point, more specifically, superheating is required. However, a superheated zinc gas cannot be obtained according to the high-frequency induction heating system because no high-frequency induction current flows into the zinc gas, and no self-heating is caused.

A continuous zinc evaporation furnace is disclosed in which the furnace has a melting and holding furnace for holding a zinc molten metal, and an evaporation furnace having an induction heating coil and a graphite crucible, the melting and holding furnace and a lower part of the evaporation furnace are connected with a communication tube made from a graphite sleeve, the induction heating coil is wound around a periphery of the graphite sleeve, and the whole assembly is integrally embedded in a castable cement layer (Patent literature No. 3). However, according to the apparatus having such a constitution, zinc can be continuously evaporated, but as described above, the superheated zinc gas cannot be generated. Moreover, the literature discloses or suggests no method for feeding the superheated zinc gas while controlling the rate of feed. Furthermore, the apparatus uses the graphite crucible and the graphite sleeve, and a certain amount of carbon is mixed in the zinc gas, and therefore the apparatus is not preferred.

### CITATION LIST

### Patent Literature

Patent literature No. 1: JP 2007-145663 A.
Patent literature No. 2: JP 2008-184641 A.
Patent literature No. 3: JP S61-199567 U.

### Non-Patent Literature

Non-patent literature No. 1: Seifelt D. A. and Browning M. F., “Pilot-Scale Development of the Zinc Reduction for Production of High-Purity Silicon” AIChE Symposium Series (American Institute of Chemical Engineers) No. 216, Vol. 78, p 104-115 (1982).

### SUMMARY OF INVENTION

### Technical Problem

An object of the invention is to provide a method for feeding at a controlled rate of feed a zinc gas superheated to a temperature equal to or higher than a boiling point of zinc. Another object is to provide a method for efficiently feeding a superheated zinc gas by controlling the superheated zinc gas at a large rate of feed. A further object is to provide a method for feeding the superheated zinc gas while suppressing an amount of impurity entrained with the zinc gas, and an apparatus applied to the method.

### Solution to Problem

The present inventors have diligently conducted research to achieve the object, and as a result, have found that a rate of generating a zinc gas can be controlled by an amount of electric power to be input into a high-frequency induction heating means, and thus have completed the invention. The invention includes items 1 to 9 as described below.

[1] A method for feeding a zinc gas, including:

step (1) for introducing melt zinc into a zinc gas evaporation apparatus,

step (2) for generating the zinc gas from the melt zinc by inputting electric power corresponding to a rate of feed of the zinc gas to allow zinc to cause self-heating by high-frequency induction heating,

step (3) for introducing the generated zinc gas into a gas heating apparatus, and

step (4) for heating the zinc gas by resistance heating to form a superheated zinc gas.

[2] The method for feeding the zinc gas according to item [1], wherein the step (2) is performed when a liquid level of the melt zinc in the zinc gas evaporation apparatus is in the range of 40% to 100% in a liquid level height.

[3] The method for feeding the zinc gas according to item [1] or [2], wherein a temperature of the melt zinc introduced into the zinc gas evaporation apparatus is in the range of 430 to 700° C.,

a temperature of the zinc gas generated by high-frequency induction heating is at a boiling point temperature of zinc, and

a temperature of the superheated zinc gas is in the range of the boiling point temperature of zinc to 1,100° C.

[4] The method for feeding the zinc gas according to any one of items [1] to [3], wherein the melt zinc introduced into the zinc gas evaporation apparatus is at least one kind of melt zinc selected from the group consisting of melt zinc obtained by electrolyzing zinc chloride and melt zinc obtained by melting electrolytic zinc, pyrometallurgical zinc or recycled zinc.

[5] The method for feeding the zinc gas according to item [4], wherein the melt zinc introduced into the zinc gas evaporation apparatus is obtained by electrolyzing zinc chloride.

[6] The method for feeding the zinc gas according to any one of items [1] to [5], wherein the step (1) includes a step for introducing the melt zinc into the zinc gas evaporation apparatus while measuring a weight and a temperature of the melt zinc in the zinc gas evaporation apparatus, and

the step (2) includes a step for generating the zinc gas from the melt zinc by inputting electric power corresponding to a rate of feed of the zinc gas calculated from an amount of heat radiation of the zinc gas evaporation apparatus and apparatus efficiency of high-frequency induction heating to allow zinc to cause self-heating by high-frequency induction heating.

[7] The method for feeding the zinc gas according to any one of items [1] to [5], further including

a step for inputting high-frequency induction electric power corresponding to an amount of heat radiation of the apparatus when an inside of the zinc gas evaporation apparatus is at a boiling point temperature of zinc until a temperature of a melt in the zinc gas evaporation apparatus reaches the boiling point temperature of zinc to increase a temperature of melt zinc to the boiling point temperature of zinc, and

a step for introducing the melt zinc into the zinc gas evaporation apparatus while measuring the weight and the temperature of the melt zinc in the zinc gas evaporation apparatus from the time at which the temperature of the melt in the zinc gas evaporation apparatus reaches the boiling point temperature of zinc,

wherein the step (2) includes a step for inputting electric power corresponding to a rate of feed of the zinc gas to generate the zinc gas at an objective rate from the melt zinc by high-frequency induction heating.

[8] The method for feeding the zinc gas according to any one of items [1] to [5], wherein the step (1) includes a step for introducing the melt zinc into the zinc gas evaporation apparatus at a rate identical with a rate of feed of the zinc gas while measuring the weight and temperature of the melt zinc in the zinc gas evaporation apparatus and the temperature of the melt zinc introduced into the zinc gas evaporation apparatus, and

the step (2) includes a step for generating the zinc gas from the melt zinc by inputting electric power corresponding to the rate of feed of the zinc gas calculated from the amount of heat radiation of the zinc gas evaporation apparatus, the apparatus efficiency of high-frequency induction heating and the temperature of the melt zinc introduced into the zinc gas evaporation apparatus to allow zinc to cause self-heating by high-frequency induction heating, and

introduction of the melt zinc and generation of the zinc gas are continuously performed.

[9] An apparatus for feeding a zinc gas, applied to the method for feeding the zinc gas according to any one of items [1] to [8], and including a zinc gas evaporation apparatus, a gas heating apparatus and a control apparatus.

### Effects of Invention

According to a method described in item [1], a superheated zinc gas can be generated at an objective rate of feed by controlling electric power input into a high-frequency induction heating means. Moreover, control can be made by separating a zinc gas generation step and a superheating step to facilitate the control. When an amount of input electric power is changed or stopped, changing of a rate of generating a zinc gas or stopping thereof can be simply performed.

When a method for directly heating melt zinc by high-frequency induction heating is adopted, a large amount of energy can be given and the zinc gas can be fed at a large rate of feed. Furthermore, the electric power input into the high-frequency induction heating means can be widely changed from a small amount of electric power to a large amount of electric power, and thus a rate of feeding a superheated zinc gas can be changed from a small rate to a large rate.

According to a method described in item [2], an operation can be performed while keeping a high efficiency of high-frequency induction heating, and simultaneously entrainment of an impurity in melt zinc with a zinc gas can be suppressed, and a zinc gas from which the impurity in the melt zinc is removed can be fed.

According to a method described in item [3], melt zinc to be introduced has viscosity and flow properties suitable for introduction, and a zinc gas at a boiling point temperature generated by receiving high-frequency induction heating can be immediately superheated by resistance heating.

According to a method described in item [4], a superheated zinc gas can be generated by using zinc obtained according to various production processes.

According to a method described in item [5], melt zinc in a molten state as obtained by electrolysis of zinc chloride is used, and thus formation of a melt by heating zinc is unnecessary, and energy consumption can be suppressed.

According to a method described in item [6], a superheated zinc gas can be generated at an objective rate of feed by controlling electric power input into a high-frequency induction heating means.

According to a method described in item [7], rise time until a superheated zinc gas is generated at an objective rate of feed can be shortened by controlling electric power input into a high-frequency induction heating means.

According to a method described in item [8], a superheated zinc gas can be continuously generated at an objective rate of feed by controlling electric power input into a high-frequency induction heating means.

If an apparatus descried in item [9] is used, a superheated zinc gas can be generated at an objective rate of feed by controlling electric power input into high-frequency induction heating.

### BRIEF DESCRIPTION OF DRAWINGS

FIG. 1 is a conceptual diagram of an apparatus constituting a zinc gas feed apparatus.

FIG. 2 shows one example of a cross-sectional view of a zinc gas evaporation apparatus.

FIG. 3 shows one example of a cross-sectional view of a gas heating apparatus.

FIG. 4 is a conceptual diagram showing one example of a dross treating means and one example of connection with an intake.

FIG. 5 is a diagram showing a relationship between input electric power and a rate of evaporation as obtained in Example 1.

FIG. 6 is a diagram showing a relationship between a liquid level height position and efficiency as obtained in Example 2.

FIG. 7 is a conceptual diagram showing one example in which a method for feeding a zinc gas according to the invention is applied to production of high-purity silicon.

### DESCRIPTION OF EMBODIMENTS

Hereinafter, a method for feeding a superheated zinc gas according to the invention, and an apparatus applied to the method are explained in detail.

A method for feeding a zinc gas according to the invention includes a step for introducing melt zinc into a zinc gas evaporation apparatus, a step for generating the zinc gas from the melt zinc by inputting electric power corresponding to a rate of feed of the zinc gas to allow zinc to cause self-heating by high-frequency induction heating, a step for introducing the generated zinc gas into a gas heating apparatus, and a step for heating the zinc gas by resistance heating to form a superheated zinc gas.

Here, zinc has values of physical properties and values of thermo-physical properties as shown in Tables 1 to 3 below.

TABLE 1
Physical properties of zinc

| | | | | |
|---|---|---|---|---|
| Molecular weight | 65.4 | g/mol | | |
| Melting point | 693 | K | 420° | C. |
| Boiling point | 1,180 | K | 907° | C. |
| Heat of fusion | 7.322 | kJ/mol | 112 | kJ/kg |
| Heat of vaporization | 115.3 | kJ/mol | 1,764 | kJ/kg |

TABLE 2
Thermo-physical properties of zinc

| | | | | | Specific | |
|---|---|---|---|---|---|---|
| | | | | | heat at | Thermal |
| | | | | Coefficient | constant | conduc- |
| | Temperature | | Density | of viscosity | pressure | tivity |
| Phase | K | ° C. | kg/cm³ | Pa · s | J/kg · K | W/m · K |
| Solid | 300 | 27 | 7,131 | — | 389 | 121.0 |
| | 600 | 327 | 6,929 | — | 443 | 105.0 |
| Liquid | 693 | 420 | 6,660 | 3.26E−03 | 505 | 58.8 |
| | 773 | 500 | 6,587 | 2.77E−03 | 491 | 57.8 |
| | 800 | 527 | 6,563 | 2.61E−03 | 486 | 57.4 |
| | 900 | 627 | 6,478 | 2.17E−03 | 475 | 57.0 |
| | 1,000 | 727 | 6,415 | 1.80E−03 | 466 | 56.4 |
| | 1,180 | 907 | 6,302 | 1.13E−03 | 450 | 55.3 |
| Vapor | 1,180 | 907 | 0.675 | 5.38E−03 | 318 | 0.0219 |
| | 1,223 | 950 | 0.651 | 1.13E−03 | 318 | 0.0226 |

TABLE 3
Vapor pressure of zinc

| | |
|---|---|
| Temperature | Vapor pressure |

| K | ° C. | kPa |
|---|---|---|
| 693 | 420 | 0.0 |
| 773 | 500 | 0.2 |
| 823 | 550 | 0.6 |
| 873 | 600 | 1.5 |
| 923 | 650 | 3.6 |
| 973 | 700 | 8.0 |
| 1,023 | 750 | 16.3 |
| 1,073 | 800 | 31.2 |
| 1,123 | 850 | 56.1 |
| 1,173 | 900 | 95.7 |
| 1,180 | 907 | 102.7 |
| 1,183 | 910 | 105.9 |
| 1,193 | 920 | 116.9 |
| 1,203 | 930 | 128.9 |
| 1,212 | 940 | 141.9 |
| 1,223 | 950 | 156.0 |

Heat of vaporization of zinc is 1,764 kJ/kg, which is larger by approximately one digit in comparison with an amount of heat of 233 kJ/kg necessary for heating melt zinc at 420° C. to 907° C. (calculated, as specific heat, using a mean value of specific heat at constant pressure at 420° C. and specific heat at constant pressure at 907° C. in Table 2). Accordingly, in order to heat melt zinc at approximately 420° C. to generate the zinc gas, efficient application of energy to the melt zinc becomes important in a stage for vaporizing the melt zinc. In order to superheat the zinc gas to form a zinc gas at 1,100° C., application of heat in an amount of 61.4 kJ/kg is sufficient. In order to form a zinc gas at a reaction temperature for producing high-purity silicon by reducing silicon tetrachloride with the zinc gas, for example, a zinc gas at 950° C., application of heat in an amount of 13.7 kJ/kg is sufficient. Suitable selection of a heating method in a vaporization stage is found to be an important technology relating to feed of the superheated zinc gas.

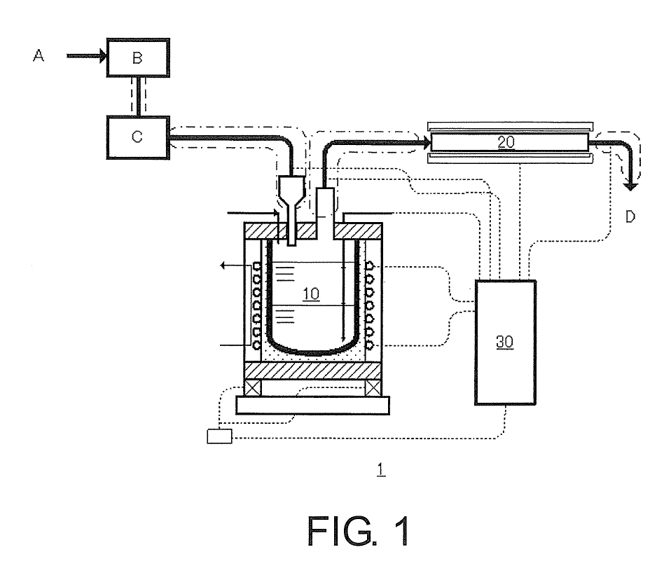

FIG. 1 is a conceptual diagram showing one example of an apparatus for feeding a zinc gas superheated according to a method of the invention. Zinc gas feed apparatus 1 has zinc gas evaporation apparatus 10, gas heating apparatus 20 and control apparatus 30. Control apparatus 30 detects and displays quantity of state such as a temperature of the melt zinc to be introduced, a weight of zinc gas evaporation apparatus 10, a temperature of the melt zinc in zinc gas evaporation apparatus 10 and a temperature of gas heating apparatus 20, and based on the quantity of state, to control electric power input into zinc gas evaporation apparatus 10 and gas heating apparatus 20 and to control a rate of generating the zinc gas. Melt zinc supplied from generation source A is measured by measuring means B, and introduced into zinc gas evaporation apparatus 10 through dross treatment means C. Piping between apparatuses, for example, between measuring means B and dross treatment means C, and between zinc gas evaporation apparatus 10 and gas heating apparatus 20, is thermally insulated with a heat insulating material, and further heated as required.

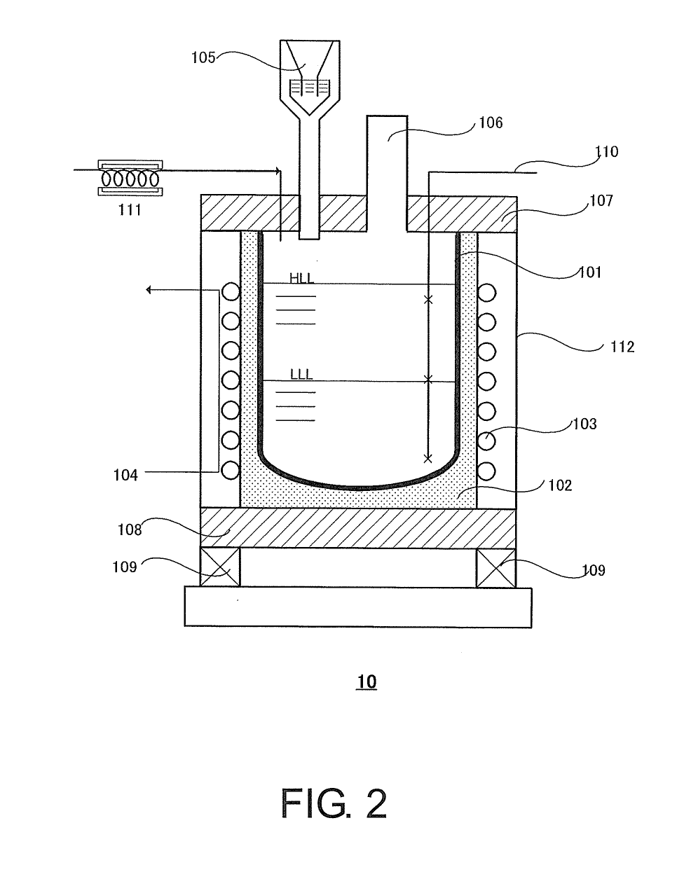

FIG. 2 is a conceptual diagram showing one example of zinc gas evaporation apparatus 10. Zinc gas evaporation apparatus 10 has crucible 101 for holding molten zinc, heat insulating material 102 installed so as to hold and surround crucible 101, and further induction coil 103 wound around the circumference thereof. In an upper part of crucible 101, evaporator cover 107 having intake 105, zinc gas outlet 106, thermometry opening 110 and inert gas inlet 111 are arranged. Heat insulating material 102 for holding crucible 101 is arranged on bottom plate 108, and further installed on weighing instrument 109. The whole assembly is surrounded by casing 112. Induction coil 103 is connected to electric power supply facilities (not shown) including an inverter and a capacitor bank, and induction coil cooling facilities (not shown). The electric power supply facilities are controlled by control apparatus 30.

Crucible 101 preferably has a cylindrical shape because uniform heating of internally held molten zinc is required with induction coil 103 arranged around the molten zinc. Crucible 101 having a round-bottom shape is further preferred because such crucible 101 is hard to generate an internal distortion and has a high strength. A material of crucible 101 is not particularly limited, if the material can hold the melt zinc, has resistance in an operating temperature range, and does not affect a quality of the melt zinc. For example, quartz and a ceramic material are a preferred material, and quartz being a nonconductor is particularly preferred. Crucible 101 made from quartz being the nonconductor is not inductively heated, and the melt zinc is directly heated. Therefore, evaporation is stopped immediately after supply of electric power is stopped.

A height, a diameter and a radius of curvature of a bottom of crucible 101, and a height and a diameter of induction coil 103 are not particularly limited, but may be determined depending on a depth of penetration of an induced current, efficiency of induction heating, an evaporation area and a required amount of evaporation. A larger elongation further increases induction heating efficiency, and a larger diameter further increases the evaporation area. For example, when using quartz crucible 101 having an external diameter of 460 mm, an internal diameter of 400 mm, a radius of curvature of 230 mm and a height of 750 mm, and induction coil 103 having a height of 500 mm and an internal diameter of 550 mm, and arranging an upper end of induction coil 103 on a position lower than an upper end of crucible 101 by 220 mm, a weight of the melt zinc when the melt zinc is charged up to the upper end of the induction coil becomes approximately 330 kg. A weight of the melt zinc at 40% in a liquid level height position becomes approximately 90 kg. A difference of 240 kg corresponds to an amount of zinc gas that can be fed without additionally introducing the melt zinc into zinc gas evaporation apparatus 10. Here, a liquid level height position (%) is defined as a relative height from a lower end of induction coil 103 in terms of percentage (%) when a height of the upper end of induction coil 103 is defined as 100(%). A fused silica tube having a diameter of approximately 900 mm is commercially available, and can be processed into a crucible having a large diameter.

The upper end of induction coil 103 may be arranged so as to have, as measured from the upper part of crucible 101, an allowance larger than a height of melt rise occurring when the melt zinc is inductively heated. For example, the melt zinc rises by approximately 200 mm when 330 kg of melt zinc is charged into crucible 101 having the size described above, and subjected to 500 Hz high-frequency induction heating at an evaporation rate of 400 kg/hr. Therefore, the upper end of induction coil 103 may be arranged with an allowance of 200 mm or more from the upper part of crucible 101.

Crucible 101 is surrounded and held with heat insulating material 102. Heat insulating material 102 is not particularly limited, if the material has strength allowing sustainment of crucible 101 holding the melt zinc, is not inductively heated and has a small thermal conductivity. For example, as heat insulating material 102, silica sand, silica powder, and a castable material containing silica sand or silica powder are preferred, and when maintenance is taken into consideration, silica sand is further preferred. Heat insulating material 102 may be filled and installed so as to fill a clearance between induction coil 103 and crucible 101.

A material of evaporator cover 107 is not particularly limited, if the material has resistance to the zinc gas, a small thermal conductivity, is not inductively heated and can be processed so as to allow attachment of intake 105 or zinc gas outlet 106. For example, quartz and a ceramic material are preferably used. Evaporator cover 107 made from quartz may be covered with a ceramic fiberboard or blanket. As the ceramic material, a silica-alumina based low cement castable can also be used.

A material of bottom plate 108 is not particularly limited, if the material has a small thermal conductivity, is not inductively heated and is processable. For example, a ceramic material is preferably used, and as the ceramic material, a silica-alumina based low cement castable can also be used.

A structure of intake 105 is not particularly limited, if intake 105 has a liquid seal mechanism so as to feed the melt zinc without causing a backward flow of an evaporated zinc gas. The structure may have a constitution in which the liquid seal mechanism is externally arranged as shown in FIG. 2, or may have a constitution in which a pipe for introducing the melt zinc is extended into an inside of the melt zinc to be held in crucible 101 to form the liquid seal mechanism. A material used for intake 105 is not particularly limited, if the material has resistance to the melt zinc and the zinc gas and is processable. For example, quartz and a ceramic material are preferably used. Quartz is particularly preferred because of easy processability thereof.

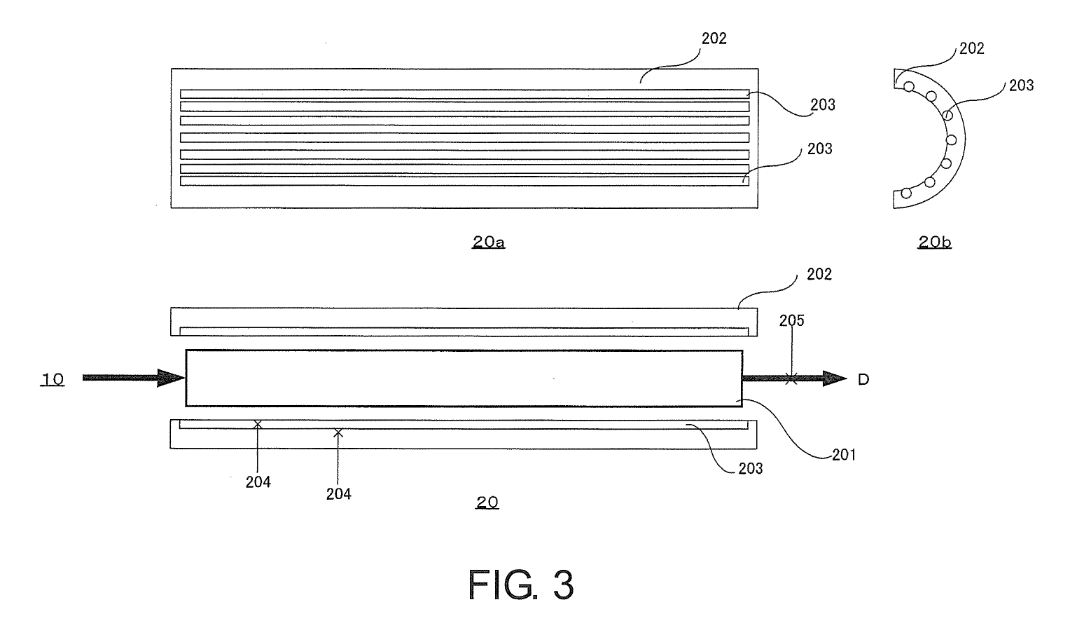

FIG. 3 is a conceptual diagram showing one example of gas heating apparatus 20 for receiving an evaporated zing gas to superheat the zinc gas. Gas heating apparatus 20 has heating zone 201, heat-insulating protective cover 202, resistive heater 203, thermometer 204 and zinc gas thermometer 205. As a specific example of a system, heating zone 201 has a hollow pipe structure and is heated from outside by means of resistive heater 203. A structure further having a heating mechanism inside the heating zone 201 may be formed, or a structure having a zinc gas-resistant packing or assembly arranged inside the heating zone 201 may be formed. A material of heating zone 201 is not particularly limited, if the material has resistance to the zinc gas at an operating temperature and is processable. For example, quartz and a ceramic material are preferably used, and quartz is particularly preferably used because of a good processability thereof.

A length and an internal diameter of heating zone 201 may be designed so as to ensure a required heating area by considering a rate and a temperature of feed of the zinc gas and a heating temperature of resistive heater 203. Resistive heater 203 may be selected, depending on a superheating temperature, from resistive heaters using a Kanthal wire, silicon carbide and molybdenum disilicide, and used. As 20a or 20b shown in FIG. 3, a shape may be formed in which straight pipe resistive heater 203 are incorporated into dividable heat-insulating protective cover, and a bendable resistive heater may be arranged so as to surround heating zone 201.

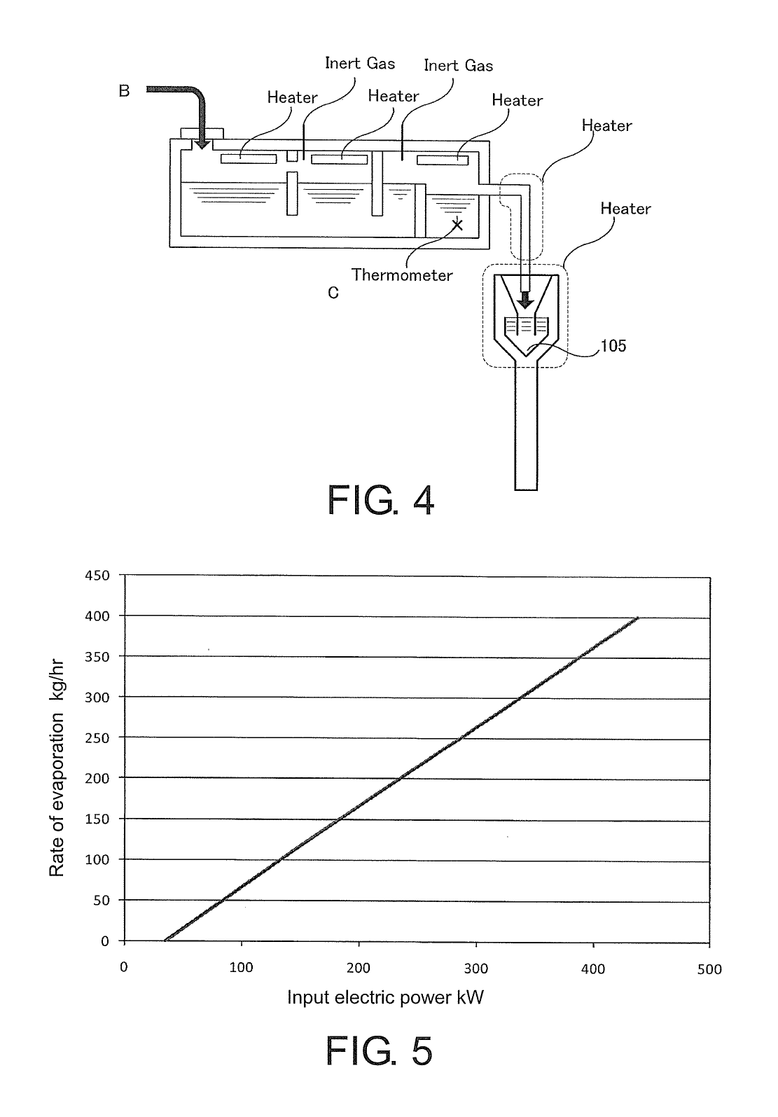

FIG. 4 is a conceptual diagram showing one example of dross treatment means C according to a submerged weir system, in which dross treatment means C is connected to a part before intake 105 and used. The melt zinc may occasionally contain dross formed by coming in contact with air or by interaction with the material used, upon storage, transport, measurement or the like, until the melt zinc is introduced into zinc gas generation apparatus 1. In order to prevent dross from flowing into the zinc gas evaporation apparatus, dross treatment means C internally having a plurality of weirs is preferably arranged in a part before intake 105. An apparatus material used for dross treatment means C is not particularly limited, if the material has resistance to the melt zinc and is processable. For example, quartz and a ceramic material are preferably used, and can also be used in combination with quartz and the ceramic material. Moreover, dross treatment means C preferably has a mechanism for adjusting a temperature of the melt zinc introduced by heating, and a mechanism for introducing an inert gas to prevent the melt zinc from contact with air.

As measuring means B, such a means can be utilized as formed by combining a method for transferring the melt zinc using a ladle or a pump with a method for calculating an amount of introduction by detecting a change of weight of transferred melt zinc, or combining a method for transferring the melt zinc using a pump with a method for calculating an amount of introduction from a discharge rate of the pump. Furthermore, flow control using a valve, a method for installing a weir on the way of a flow, or the like can be combined with the means.

Feed of the zinc gas is performed by a method as described below. The melt zinc supplied from generation source A is measured by measuring means B, and then put into dross treatment means C, and dross is treated. Melt zinc flowing out of dross treatment means C is introduced from intake 105 into zinc gas evaporation apparatus 10 through a sealing structure using, for example, an inert gas so as to prevent penetration of air (certain amount of oxygen).

Temperature T₁ of the melt zinc introduced into zinc gas evaporation apparatus 10 is measured by a thermometry means arranged in a dross treatment means, for example. An amount of the melt zinc introduced into gas evaporation apparatus 10 is determined by measuring a change of weight of zinc gas evaporation apparatus 10 using weighing apparatus 109. Temperature T₂ of the melt zinc in zinc gas evaporation apparatus 10 is measured by a temperature detecting means such as a thermocouple detector protected with a protective tube (made from quartz, for example) inserted from thermometry opening 110.

Temperature T₁ of the melt zinc introduced into zinc gas evaporation apparatus 10 is preferably in the range of 430 to 700° C., further preferably, in the range of 450 to 600° C., still further preferably, 450 to 550° C. Zinc changes into the melt zinc at 420° C. or higher to show a low viscosity and high flow properties, and therefore melt zinc maintained at 420° C. or higher is sufficient, and melt zinc at 430° C. or higher is preferred because of less fear of condensation. A vapor pressure of zinc is as low as 8 kPa at 700° C., and therefore zinc preferably has a temperature of 700° C. or lower in view of the vapor pressure.

As the melt zinc to be introduced, such melt zinc can be used as produced from molten salt electrolysis of zinc chloride and obtained by melting electrolytic zinc, pyrometallurgical zinc or recycled zinc according to an ordinarily performed method. The melt zinc to be introduced may be used in one kind or in combination with two or more kinds.

With regard to molten salt electrolysis of zinc chloride, electrolysis is performed at approximately 450 to approximately 500° C. in any case of performing electrolysis using a simple salt or double salt. In any case of electrolysis using the simple salt or double salt, the melt zinc is produced at 450 to 500° C. being a temperature of a melting point of zinc or higher and an electrolytic temperature or lower. A case where the melt zinc at 450 to 500° C. produced from molten salt electrolysis is introduced is particularly preferred because an amount of energy required for high-frequency induction heating in zinc gas evaporation apparatus 10 becomes small.

With regard to the height of the liquid level of the melt zinc in zinc gas evaporation apparatus 10, the melt zinc is introduced into zinc gas evaporation apparatus 10 in advance to determine a relationship between an amount displayed on weighing apparatus 109 and a height of the liquid level, measuring a value on weighing apparatus 109, and then the height of the liquid level is determined according to the relational expression. A change of density by a temperature of the melt zinc is small, and therefore the liquid level of the melt zinc can be calculated with high accuracy from a weight on weighing apparatus 109.

Apparatus efficiency K at which electric power input into zinc gas evaporation apparatus 10 is converted into heating energy is determined as described below. The melt zinc is introduced into zinc evaporation apparatus 10, and a rate of weight reduction of zinc gas evaporation apparatus 10 is measured while changing an amount of input electric power to determine a relational expression between the amount of input electric power and the rate of weight reduction. Apparatus efficiency K is determined from a ratio of an inclination of the rate of weight reduction relative to input electric power, to an inclination of the rate of weight reduction calculated from heat of vaporization of zinc relative to the input electric power.

An amount of heat radiation (Q_{V}: unit kW) from zinc gas evaporation apparatus 10 is calculated from input electric power (W_{V}: unit kW) when the rate of weight reduction is zero, more specifically, from an amount of input electric power necessary for heating to achieve equilibrium with the amount of heat radiation, according to equation 1 as described below.

Q_{V}=W_{V}×K (equation 1).

Apparatus efficiency K changes depending on a positional relationship between a height of the melt zinc in zinc evaporation apparatus 10 and induction coil 103. Thus, generation of the zinc gas is necessary to be performed in the range of a positional relationship between a height of the melt zinc and induction coil 103 in which a change of apparatus efficiency is not significant. When a range of melt zinc presence is significantly narrower than a height of the induction coil, more specifically, a range in which heating can be made with the induction coil, efficiency for utilizing energy input into the induction heating means for heating energy decreases, and an amount of evaporation of the zinc gas corresponding to input electric power is no longer obtained. A range of induction coil 103 and a liquid level of the melt zinc is determined in advance in which a change of apparatus efficiency K of the induction coil does not become significant, and induction heating is performed within the range to generate the zinc gas corresponding to the input electric power.

In order to generate the zinc gas at a feed rate (V_{V}: unit kg/hr) from the melt zinc introduced into zinc gas evaporation apparatus 10 and heated up to boiling point temperature T_{b}, electric power (W_{I}: unit kW) calculated according to equation 2 as described below may be input into the induction heating means. Thus, the zinc gas at boiling point temperature T_{b} is generated at a rate of V_{V}. If electric power W_{I} input into the induction heating means is changed, the zinc gas can be generated at the feed rate corresponding to the amount.

W_{I}=(V_{V}/3600×1764)/K+W_{V} (equation 2).

A preferred embodiment of an operation for generating the zinc gas using zinc gas evaporation apparatus 10 is as described below. The melt zinc at temperature T₁ is introduced into zinc gas evaporation apparatus 10, based on an amount displayed on weighing apparatus 109, to a level near an upper end of induction coil 103, and electric power W_{I} calculated according to equation 2 is input. A state of zinc gas evaporation apparatus 10 is detected by measuring temperature T₂ and a change of an amount displayed on weighing apparatus 109. In a state in which temperature T₂ is less than temperature T_{b}, the melt zinc is in a temperature rise state, and no zinc gas is generated. From a time point at which temperature T₂ becomes equal to temperature T_{b} and constant and the amount displayed on weighing apparatus 109 begins to change, the zinc gas is generated at a rate of V_{V} by inputting electric power W_{I} calculated according to equation 2. The zinc gas can be fed at a fixed rate of feed corresponding to input electric power W_{I} until the liquid level of the melt zinc in zinc gas evaporation apparatus 10 becomes 40% in the liquid level height position, further preferably, 50% in the liquid level height position.

With regard to input electric power until temperature T₂ of the melt zinc reaches boiling point temperature T_{b}, a higher electric power may be supplied within a permissible output range of the apparatus in place of electric power W_{I} corresponding to the rate of feed of zinc gas V_{V}. Input electric power may be decreased from a time point at which temperature T₂ of the melt zinc reaches boiling point temperature T_{b}, or may be brought closer to W_{I} as temperature T₂ of the melt zinc approaches boiling point temperature T_{b}. Thus, a period of time for raising temperature of the melt zinc up to boiling point temperature T_{b} can be shortened.

In order to generate the zinc gas, while continuously introducing the melt zinc at temperature T₁ into zinc gas vaporization apparatus 10 at an introduction rate (V_{IN}: unit kg/hr), at the feed rate V_{V} identical with the introduction rate, more specifically, in a state of V_{IN}=V_{V}, electric power W_{I} calculated according to equation 3 as described below may be input into the induction heating means. Thus, the zinc gas at boiling point temperature T_{b} can be continuously generated at the feed rate V_{V}, wherein C in equation 3 is a mean value of specific heat at a constant pressure of the melt zinc at temperature T₁ and specific heat at constant pressure of the melt zinc at temperature T_{b}.

W_{I}=(V_{V}/3600×(1764+C(T_{b}−T₁))/K+W_{V} (equation 3).

A state of zinc gas evaporation apparatus 10 is detected by observing temperature T₂ and a change of the amount displayed on weighing apparatus 109. When temperature T₂ is equal to temperature T_{b} and no change of weighing apparatus 109 is observed, the zinc gas is generated at a mean rate of V_{V}.

When temperature T₂ is in a state equal to temperature T_{b}, but the amount displayed on weighing apparatus 109 decreases, it is in a state in which introduction temperature T₁ of the melt zinc is higher than an original setting, or in a state in which an introduction rate V_{IN} of the melt zinc decreases. Then, introduction temperature T₁ or introduction rate V_{IN} is corrected so as to suppress a change in weighing apparatus 109. When temperature T₂ is in a state equal to temperature T_{b}, but the amount displayed on weighing apparatus 109 increases, it is in a state in which introduction temperature T₁ of the melt zinc is lower than an original setting, or in a state in which introduction rate V_{IN} of the melt zinc increases. Then, introduction temperature T₁ or introduction rate V_{IN} is corrected so as to suppress a change in weighing apparatus 109. More specifically, the zinc gas can be generated at the mean rate of V_{V} by inputting electric power W_{I} into the induction heating means, and the zinc gas can be generated while maintaining the mean rate of V_{V} by further controlling introduction temperature T₁ of the melt zinc or introduction rate V_{IN} thereof so as to suppress a change in weighing apparatus 109.

The zinc gas at boiling point temperature T_{b} generated from zinc gas evaporation apparatus 10 is introduced into gas heating apparatus 20 through piping maintained at a temperature equal to or higher than the boiling point temperature. The zinc gas is superheated to a temperature equal to or higher than the boiling point to approximately 1,100° C., preferably, approximately 940 to approximately 1,100° C., still further preferably, approximately 950 to approximately 1,050° C. through heating zone 201 heated to 1,100 to 1,200° C. using resistive heater 203, for example. A length and an internal diameter of heating zone 201 may be designed so as to ensure a heat transfer area for satisfying a rate and a temperature range of feeding the zinc gas. Although a temperature range to which heating can be achieved using resistive heater 203 is different depending on types of heaters, in a case of a resistive heater using an easily available Kanthal wire, it is preferably used when feeding the zinc gas as a zinc gas superheated to the temperature range of the boiling point or higher to 1,100° C. because an upper limit of usable temperature is approximately 1,200° C.

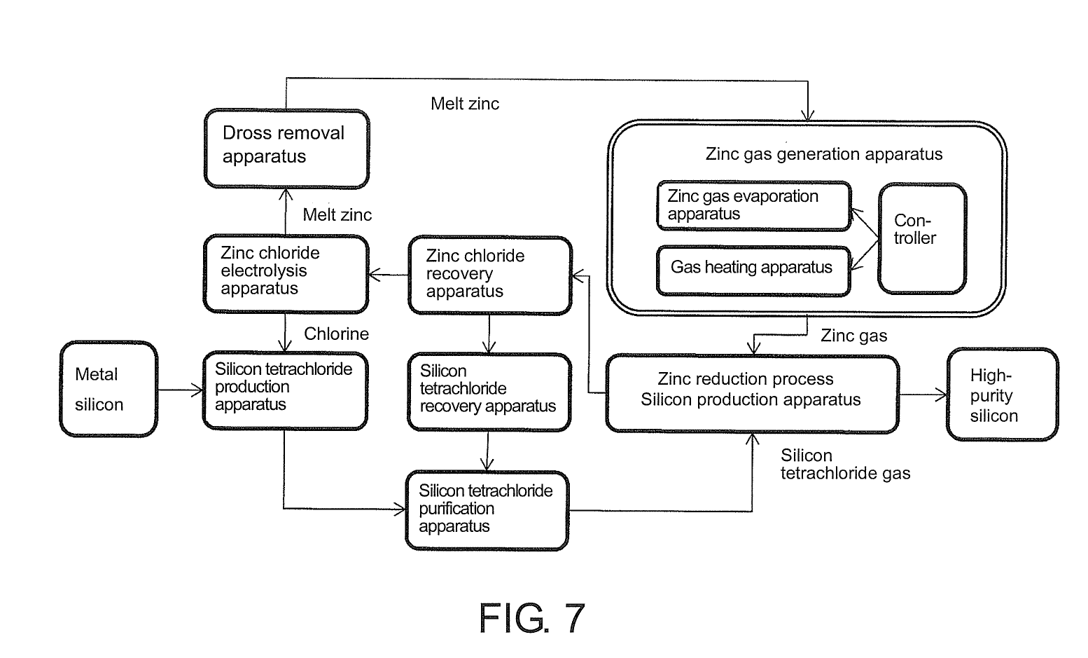

FIG. 7 is a conceptual diagram showing one example of a relationship between individual steps relating to production of high-purity silicon according to a zinc reduction process. FIG. 7 shows that by-product zinc chloride that is discharged from a silicon production step according to the zinc reduction process is separated and recovered, zinc chloride separated and recovered is supplied to a molten salt electrolytic step, dross is removed from the melt zinc fed in a melt state and the resultant melt zinc is introduced into a zinc gas generation apparatus, a zinc gas is fed at a controlled rate of feed by a method according to the invention and can be used again for production of silicon according to the zinc gas reduction process.

### EXAMPLES

Hereinafter, the invention is explained in more detail byway of Examples, but the range of the invention is in no way limited thereto.

### Example 1

Zinc gas evaporation apparatus 10 used had fused silica crucible 101 having an external diameter of 460 mm, an internal diameter of 400 mm, a radius of curvature of 230 mm and a height of 750 mm, and induction coil 103 having a height of 500 mm and an internal diameter of 550 mm. Crucible 101 was placed on bottom plate 108 made from a silica-alumina based low cement castable. A circumference of crucible 101 was thermally insulated with silica sand, evaporator cover 107 made from quartz was attached, and an upper part was covered with a ceramic fiberboard and an entire crucible assembly was placed on weighing apparatus (floor scale) 109. A power supply having a frequency of 500 Hz and an output power of 600 kW was used for high-frequency induction heating.

Into such zinc gas evaporation apparatus 10, 330 kg of melt zinc at 450° C. was introduced, subjected to high-frequency induction heating, and heated to a boiling point temperature. Input electric power for performing high-frequency induction heating was changed to determine an approximate expression of a relationship between input electric power and a rate of weight reduction (rate of evaporation of zinc). The results are shown in FIG. 5. In the apparatus used for testing, an inclination became 1.0 (kg/hr·kW) and input electric power W_{V} when a rate of weight reduction was zero became 35 kW, and the rate of weight reduction showed a linear relationship with input electric power. Capability of evaporating zinc at a corresponding rate is confirmed by changing input electric power. An inclination of a rate of evaporation of zinc relative to input electric power as determined from heat of vaporization was 2.04 (kg/hr·kW), apparatus efficiency K of zinc gas evaporation apparatus 10 used in Example became 50%, and an amount of heat radiation Q_{V} was 17.5 kW.

### Example 2

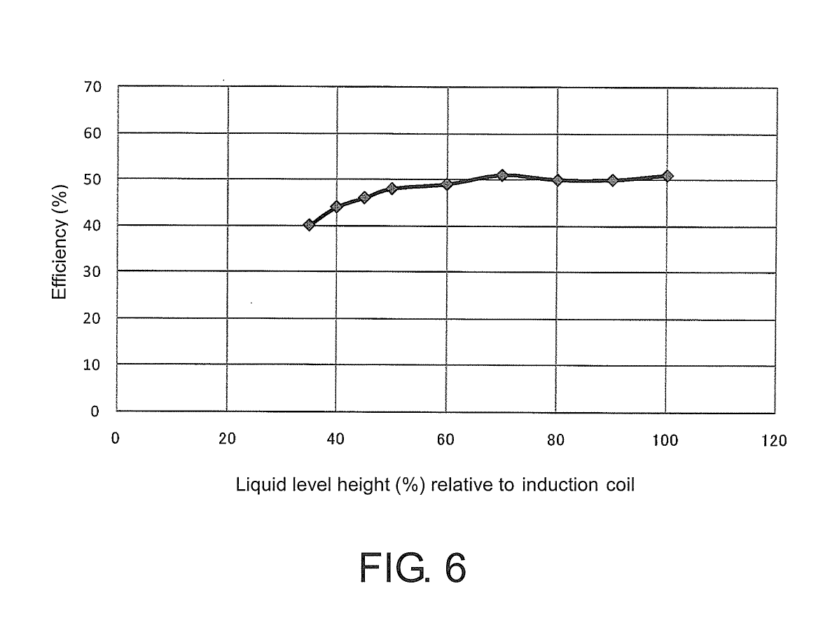

A change of apparatus efficiency K when a liquid level of melt zinc changed was determined by using an apparatus similar to the apparatus in Example 1. The results are shown in FIG. 6. When the liquid level of melt zinc was above 50% in a liquid level height position, no substantial change was caused, and when the liquid level of melt zinc became lower than 40% in the liquid level height position, a clear decrease of apparatus efficiency K was observed. The finding shows that, if the liquid level is maintained in a range higher than 40% in the liquid level height position of melt zinc, no significant change of apparatus efficiency K is caused and a zinc gas can be generated by controlling the generation with input electric power, and if the liquid level is maintained at a range higher than 50% in the liquid level height position, induction heating can be performed with high accuracy.

### Example 3

To zinc gas evaporation apparatus 10 similar to the apparatus in Example 1, gas heating apparatus 20 having fused silica heating zone 201 having a length of 3,000 mm and an internal diameter of 100 mm as heated to 1,100° C. using a Kanthal wire heater was connected, and further an outlet of gas heating apparatus 20 was connected to a zinc gas cooling and recovery device. Feed of a superheated zinc gas was tested using melt zinc obtained by performing molten salt electrolysis. The cooling and recovery device was made from steel having a surface lined with a ceramic caster material having a large thermal conduction, circumferentially surrounded with a water cooled jacket, and placed on a weighing apparatus (floor scale) to allow measurement of an amount of cooled and recovered zinc.

Testing for generating a zinc gas at a feed rate of V_{V}=250 kg/hr was conducted. Corresponding input electric power was calculated to be W_{I}=280 kW. Then, 330 kg of melt zinc at 450° C. as obtained by performing molten salt electrolysis was introduced into zinc gas evaporation apparatus 10, and an electric power of 280 kW was input. Temperature T₂ of melt zinc began to rise to reach a boiling point temperature in approximately 10 minutes, an amount displayed on weighing apparatus (floor scale) 109 began to decrease, and a zinc gas began to generate. A temperature of zinc gas thermometer 205 installed in gas heating apparatus 20 showed a substantially fixed value at 950 to 970° C. Electric power was input until the amount displayed on weighing apparatus (floor scale) 109 showed a weight corresponding to 40% in a liquid level height position as a height of the liquid level of melt zinc, and a zinc gas was continuously generated, and then input of electric power was stopped and testing was completed. Zinc gas evaporation apparatus 10 generated 238 kg of zinc gas in 59 minutes from start to stop of electric power input. A rate of generating the zinc gas was calculated to be 242 kg/hr.

### Example 4

Steel wool was dissolved into melt zinc obtained by performing molten salt electrolysis to prepare simulative melt zinc in which an impurity is mixed, and testing of generation and recovery of a zinc gas was conducted using the melt zinc in a manner similar to Example 3. A sample for analysis was collected from zinc recovered in a cooling and recovery device, and pretreated by an ordinarily performed method. Impurity analysis in zinc was performed by inductively coupled plasma-atomic emission spectroscopy (ICP-AES). The results are shown in Table 4.

TABLE 4
Results of analysis of impurities in zinc (ppm)

| | Measurement items | | |
|---|---|---|---|
| Sample name | Fe | Ni | Cr |
| Simulative melt zinc | 500 | 65 | 15 |
| Recovered melt zinc | <1 | <1 | <1 |

Results of analysis in Table 4 show that the impurity mixed in the simulative melt zinc is not contained in recovered zinc, and an advantageous effect of allowing feed of a zinc gas that is purified by removal of the impurity is obtained according to the method.

### INDUSTRIAL APPLICABILITY

A method and an apparatus according to the invention can be effectively applied to feed of a zinc gas in a method for producing high-purity silicon according to a zinc reduction process for reducing silicon tetrachloride using the zinc gas. Furthermore, the method and the apparatus according to the invention allow electrolysis of by-product zinc chloride from the zinc reduction process, and receiving of melt zinc obtained to be fed as the zinc gas, and realize recycle use of zinc used for the zinc reduction process.

### REFERENCE SIGNS LIST

1 . . . Zinc gas feed apparatus
   10 . . . Zinc gas evaporation apparatus
      101 . . . Crucible
      102 . . . Heat insulating material
      103 . . . Induction coil
      104 . . . Cooling water
      105 . . . Melt zinc intake
      106 . . . Zinc gas outlet
      107 . . . Evaporator cover
      108 . . . Bottom plate
      109 . . . Weighing apparatus
      110 . . . Thermometry opening
      111 . . . Inert gas inlet
      112 . . . Casing
   20 . . . Gas heating apparatus
      201 . . . Heating zone
      202 . . . Heat-insulating protective cover
      203 . . . Resistive heater
      204 . . . Thermometer
      205 . . . Zinc gas thermometer
   30 . . . Control apparatus
   A . . . Generation source of melt zinc
   B . . . Measuring means
   C . . . Dross treatment means
   D . . . Silicon production apparatus according to a zinc reduction process

1. A method for feeding a zinc gas, comprising:
a step (1) for introducing melt zinc into a zinc gas evaporation apparatus,
a step (2) for generating the zinc gas from the melt zinc by inputting electric power corresponding to a rate of feed of the zinc gas to allow zinc to cause self-heating by high-frequency induction heating,
a step (3) for introducing the generated zinc gas into a gas heating apparatus, and
a step (4) for heating the zinc gas by resistance heating to form a superheated zinc gas.

2. The method for feeding the zinc gas according to claim 1, wherein the step (2) is performed when a liquid level of the melt zinc in the zinc gas evaporation apparatus is in the range of 40% to 100% in a liquid level height.

3. The method for feeding the zinc gas according to claim 1, wherein a temperature of the melt zinc introduced into the zinc gas evaporation apparatus is in the range of 430 to 700° C.,
a temperature of the zinc gas generated by high-frequency induction heating is at a boiling point temperature of zinc, and
a temperature of the superheated zinc gas is in the range of the boiling point temperature of zinc to 1,100° C.

4. The method for feeding the zinc gas according to claim 1, wherein the melt zinc introduced into the zinc gas evaporation apparatus is at least one kind of melt zinc selected from a group consisting of melt zinc obtained by electrolyzing zinc chloride and melt zinc obtained by melting electrolytic zinc, pyrometallurgical zinc or recycled zinc.

5. The method for feeding the zinc gas according to claim 4, wherein the melt zinc introduced into the zinc gas evaporation apparatus is obtained by electrolyzing zinc chloride.

6. The method for feeding the zinc gas according to claim 1, wherein the step (1) comprises a step for introducing the melt zinc into the zinc gas evaporation apparatus while measuring a weight and a temperature of the melt zinc in the zinc gas evaporation apparatus, and
the step (2) comprises a step for generating the zinc gas from the melt zinc by inputting electric power corresponding to a rate of feed of the zinc gas calculated from an amount of heat radiation of the zinc gas evaporation apparatus and apparatus efficiency of high-frequency induction heating to allow zinc to cause self-heating by high-frequency induction heating.

7. The method for feeding the zinc gas according to claim 1, further comprising
a step for inputting high-frequency induction electric power corresponding to an amount of heat radiation of the apparatus when an inside of the zinc gas evaporation apparatus is at a boiling point temperature of zinc until a temperature of a melt in the zinc gas evaporation apparatus reaches the boiling point temperature of zinc to increase a temperature of melt zinc to the boiling point temperature of zinc, and
a step for introducing the melt zinc into the zinc gas evaporation apparatus while measuring the weight and the temperature of the melt zinc in the zinc gas evaporation apparatus from the time at which the temperature of the melt in the zinc gas evaporation apparatus reaches the boiling point temperature of zinc,
wherein the step (2) comprises a step for inputting electric power corresponding to a rate of feed of the zinc gas to generate the zinc gas at an objective rate from the melt zinc by high-frequency induction heating.

8. The method for feeding the zinc gas according to claim 1, wherein the step (1) comprises a step for introducing the melt zinc into the zinc gas evaporation apparatus at a rate identical with a rate of feed of the zinc gas while measuring the weight and temperature of the melt zinc in the zinc gas evaporation apparatus and the temperature of the melt zinc introduced into the zinc gas evaporation apparatus, and
the step (2) comprises a step for generating the zinc gas from the melt zinc by inputting electric power corresponding to the rate of feed of the zinc gas calculated from the amount of heat radiation of the zinc gas evaporation apparatus, the apparatus efficiency of high-frequency induction heating and the temperature of the melt zinc introduced into the zinc gas evaporation apparatus to allow zinc to cause self-heating by high-frequency induction heating, and
introduction of the melt zinc and generation of the zinc gas are continuously performed.

9. An apparatus for feeding a zinc gas, applied to the method for feeding the zinc gas according to claim 1, and including a zinc gas evaporation apparatus, a gas heating apparatus and a control apparatus.
